(19) United States
(12) Patent Application Publication
(10) Pub. No.: US 2024/0401404 A1
(43) Pub. Date: Dec. 5, 2024

(54) MOTORIZED COVERING FOR A WINDOW

(71) Applicant: MORGAN SOLAR INC., Toronto (CA)

(72) Inventors: Xin Yi LING, Woodbridge (CA); Muny TRAM, Toronto (CA); Samuel KIM, Toronto (CA); Michael MARTINS, Toronto (CA); Brett BARNES, Toronto (CA)

(21) Appl. No.: 18/693,377

(22) PCT Filed: Sep. 15, 2022
(86) PCT No.: PCT/IB2022/058729

§ 371 Date: Mar. 19, 2024

Related U.S. Application Data
(60) Provisional application No. 63/246,191, filed on Sep. 20, 2021.

(51) Int. Cl. E06B 9/264; E06B 9/24; E06B 9/322; E06B 9/68; H02S 20/26; H02S 30/20; H02S 40/22

(52) U.S. Cl. CPC E06B 9/264; E06B 9/322; E06B 9/68; H02S 20/26; H02S 30/20; H02S 40/22; E06B 2009/2417; E06B 2009/2429; E06B 2009/2458; E06B 2009/2476; E06B 2009/6818

(57) ABSTRACT

A motorized covering for a window, including a selectively positionable plurality of slats; a flexible material layer connected to the plurality of slats, the flexible material layer extending generally parallel to the window when the plurality of slats is in the extended position, a plurality of temporary air cells being formed between the plurality of slats, the flexible material layer, and the window when the slats are in the extended position; and a motor system operatively connected to the plurality of slats and the flexible material layer to selectively lower and raise the slats and the flexible material layer, the motor system being configured to lower and raise the plurality of slats and the flexible material layer in response to at least one control signal, the at least one control signal being based on a determination to change an insulation factor for the window.

### TECHNICAL FIELD

The present application claims priority to U.S. Provisional Patent Application No. 63/246,191, entitled “Motorized Covering for a Window,” filed on Sep. 20, 2021, the entirety of which is incorporated by reference herein.

### TECHNICAL FIELD

The present technology relates generally to motorized coverings for windows.

### BACKGROUND

In the overall drive to reduce and better address energy consumption, heating and cooling of buildings remain a major driver of energy consumption. Much heat transfer occurs through building windows, large office structures often having large window areas. For example, buildings are heated by sunlight radiation entering the building through the windows. Buildings may also lose heat through windows by radiative and conductive processes.

Some heat exchange through windows can be addressed by utilizing high insulation windows, for example using double or triple glazed windows. Addressing the physical window properties in an existing building often requires replacing the windows, which is generally costly. Replacement or construction with high insulation windows, however, also reduces solar heat gain or conductive loss in conditions when it could otherwise be advantageous to allow for at least some heat transmission. For example, allowing for full sunlight transmission to heat an interior of the building during winter could reduce the amount of heating necessary.

Additional proposed solutions include highly reflective solar blinds that reject sunlight, low emissivity coatings applied to glass, electrochromic glass that changes the transmission characteristics with an electric charge, and translucent solar cells that block some sunlight. Other approaches also include light diffusing or refracting films that scatter and soften sunlight. For each of these solutions, there is also a limit to the adjustability of the heat transmission in order to allow for heat flow when it could otherwise be advantageous.

There thus remains a desire for solutions for managing sunlight and heat flow through windows.

### SUMMARY

It is an object of the present technology to ameliorate at least some of the inconveniences present in the prior art.

According to an aspect of the present technology, there is provided a motorized covering for a window. The covering includes a plurality of slats connected to a motor system, the motor system being configured to raise, lower, and tilt the slats to selectively arrange the slats into a variety of sunlight and heat managing modes. The covering further includes a flexible material layer to aid in creating temporary air pockets between the material layer, the slats, and the window on which the covering is installed. By selectively creating the temporary air pockets using movable slats, the insulation factor of the window can be adjusted without requiring permanent or costly changes to the window (such as replacement of the windowpanes). In instances where allowing heat transmission through the window, for example when it would be desirous to allow radiative cooling of the building at night in the summer, or to allow solar heating of the building during the day in winter, the covering can be adjusted to a retracted position to allow heat transmission.

In different embodiments of the covering, the slats could further include one or more photovoltaic elements to be used to produce electricity using sunlight that may have otherwise been reflected away. In some embodiments, the slats could include optical facets which scatter and/or reflect incident light in a predetermined angular region, depending on the angle of incidence. In this way, the slats can reflect light back out through the window and away from the covering (to reduce sunlight entering through the covering into the interior space. At a different angle of the slats, the optical facets can direct light into the interior space in order to provide additional ambient lighting, all while partially blocking the view through the window. Such an arrangement could be used to create privacy or block glare while still allowing for natural lighting.

The slats could further include both photovoltaic elements and optical facets, to provide angular control between power generation, interior illumination, and reflecting away sunlight, depending on the particular circumstances. The covering includes, or is communicatively connected to, a controller for operating the motor system to arrange the covering in the desired position. In some cases, decisions for changing the arrangement of the covering could be made based on an energy management system.

In at least aspects of the present technology, embodiments of the covering could aid in reducing operating costs and greenhouse gas emissions associated with buildings. At least some of the above-described improvements may aid in reduction of energy consumption, as the covering could provide for selectively adjusting an insulation factor of the window, maintaining natural illumination in place of electrical lighting, and/or producing electric power from sunlight, depending on what is advantageous to the overall performance of the building at a given time and location on the building. It is therefore an object at least to provide a novel energy blind.

According to an aspect of the present technology, there is provided a motorized covering for a window. The covering includes a plurality of slats selectively positionable in at least an extended position and a retracted position; a flexible material layer connected to the plurality of slats, the flexible material layer extending generally parallel to the window when the plurality of slats is in the extended position, a plurality of temporary air cells being formed between the plurality of slats, the flexible material layer, and the window when the plurality of slats is in the extended position; and a motor system operatively connected to the plurality of slats and the flexible material layer to selectively lower and raise the plurality of slats and the flexible material layer into the extended position and the retracted position, the motor system being configured to lower and raise the plurality of slats and the flexible material layer in response to at least one control signal, the at least one control signal being based on a determination to change an insulation factor for the window.

In some embodiments, the motor system is further configured to rotate the plurality of slats in response to the at least one control signal.

In some embodiments, at least one of the plurality of slats includes a light scattering surface; the motor system is further configured to selectively tilt the plurality of slats to scatter incident sunlight thereon in a predetermined direction.

In some embodiments, the motor system is configured to selectively tilt the plurality of slats in order to maximize daylight passing through the covering.

In some embodiments, at least one of the plurality of slats includes at least one photovoltaic element; and the motor system is configured to arrange the plurality of slats to maximize the electricity generation by the at least one photovoltaic element in response to an energy harvesting control signal.

In some embodiments, the covering further includes a plurality of optical facets disposed over the at least one photovoltaic element; and scattering of light incident thereon varies by angle of incidence.

In some embodiments, the plurality of optical facets are configured to direct at least a portion of light incident thereon at a first angle of incidence toward the at least one photovoltaic element when the covering is in use; the plurality of optical facets are configured to direct at least a portion of light incident thereon at a second angle of incidence reflect light incident thereon toward the flexible material layer when the covering is in use; the plurality of optical facets are configured to direct at least a portion of light incident thereon at a third angle of incidence reflect light incident thereon away from the flexible material layer and the at least one photovoltaic element when the covering is in use.

In some embodiments, the covering further includes at least one sealing member connected to the flexible material layer, the at least one sealing member being arranged to prevent air circulation from the plurality of temporary air cells past the flexible material layer when the covering is installed over the window.

In some embodiments, the at least one sealing member extends along a vertically top edge of the flexible material layer to limit passage of heated air from upper cells of the plurality of temporary air cells.

In some embodiments, the at least one sealing member includes: a top sealing member extending across a top edge of the flexible material layer, the top sealing member being arranged to form a seal over the window by the top edge of the flexible material layer when the covering is installed over the window; a left sealing member extending across a left edge of the flexible material layer, the left sealing member being arranged to form a seal over the window by the left edge of the flexible material layer when the covering is installed over the window; and a right sealing member extending across a right edge of the flexible material layer, the right sealing member being arranged to form a seal over the window by the right edge of the flexible material layer when the covering is installed over the window.

In some embodiments, the at least one control signal is produced at least in part by an energy management system.

According to another aspect of the present technology, a motorized covering for a window, the covering including a plurality of slats selectively positionable in at least an extended position and a retracted position, each of the plurality of slats including: at least one photovoltaic element; at least one flexible material layer connected to the plurality of slats, the at least one flexible material layer extending generally parallel to the window when the plurality of slats is in the extended position; an electrical collection assembly for collecting electrical energy produced by the at least one photovoltaic element of each of the plurality of slats; and a motor system operatively connected to the plurality of slats and the flexible material layer to selectively move the plurality of slats and the flexible material layer, the motor system being configured to move the plurality of slats and the flexible material layer in response to at least one control signal.

In some embodiments, the motor system is configured to selectively lower, raise, and rotate the plurality of slats.

In some embodiments, the covering further includes a plurality of optical facets disposed over the at least one photovoltaic element; and scattering of light incident thereon varies by angle of incidence.

In some embodiments, the plurality of optical facets are configured to direct at least a portion of light incident thereon at a first angle of incidence toward the at least one photovoltaic element when the covering is in use; the plurality of optical facets are configured to direct at least a portion of light incident thereon at a second angle of incidence reflect light incident thereon toward the flexible material layer when the covering is in use; the plurality of optical facets are configured to direct at least a portion of light incident thereon at a third angle of incidence reflect light incident thereon away from the flexible material layer and the at least one photovoltaic element when the covering is in use.

In some embodiments, the motor system is configured to selectively tilt the plurality of slats in order to maximize daylight passing through the covering.

In some embodiments, the motor system is configured to arrange the plurality of slats to maximize the electricity generation by the at least one photovoltaic element of each slat in response to an energy harvesting control signal.

In some embodiments, the at least one control signal is produced at least in part by an energy management system.

In some embodiments, the motor system and the plurality of slats are configured to be selectively moveable between a plurality of mode positions when the covering is in use and installed on the window, the plurality of mode positions including a privacy mode with the plurality of slats arranged to block light passage through the covering; an energy harvesting mode with the plurality of slats arranged to direct at least some incident light toward the at least one photovoltaic cell of each of the plurality of slats; a deflection mode with the plurality of slats arranged to reflect at least some incident light back toward the window; an illumination mode with the plurality of slats arranged to reflect at least some incident light between the plurality of slats and through the flexible material layer; a viewing mode with the plurality of slats arranged generally horizontally; and a retracted mode with the plurality of slats gathered at a top portion of the covering.

In the context of the present specification, the words “first”, “second”, “third”, etc. have been used as adjectives only for the purpose of allowing for distinction between the nouns that they modify from one another, and not for the purpose of describing any particular relationship between those nouns. Further, as is discussed herein in other contexts, reference to a “first” element and a “second” element does not preclude the two elements from being the same actual real-world element.

In the context of the present specification, the term “controller” refers to any implementation of a computational or electronic controlling unit capable of receiving or creating instructions for managing and controlling electrical components connected thereto.

In the context of the present specification, the terms “sunlight”, “solar radiation”, “sun rays”, etc. are meant to be generally interchangeable and should not be assumed to refer to different entities.

Embodiments of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of embodiments of the present technology will become apparent from the following description, the accompanying drawings and the appended claims.

### BRIEF DESCRIPTION OF THE DRAWINGS

These and other features, aspects and advantages of the present technology will become better understood with regard to the following description, appended claims and accompanying drawings where:

FIG. 1 is a cross-sectional view of a motorized covering for a window, shown as installed on the window in a wall portion;

FIG. 2 is a perspective view of the covering and wall portion of FIG. 1, with a material layer having been removed;

FIG. 3 is a partial, cross-sectional view of the covering and the window of FIG. 1, with the covering arranged in a viewing mode;

FIG. 4 is a partial, cross-sectional view of the covering and the window of FIG. 1, with the covering arranged in a retracted mode;

FIG. 5 is a close-up view of a header portion of the covering of FIG. 1;

FIG. 6 is a partial, cross-sectional view of the covering and the window of FIG. 1, with the covering arranged in a privacy mode;

FIG. 7 is a partial, cross-sectional view of the covering and the window of FIG. 1, with temporary air pockets illustrated schematically;

FIG. 8 is a cross-sectional view of a slat of the covering of FIG. 1;

FIG. 9 is a partial, cross-sectional view of the covering and the window of FIG. 1, with the covering arranged in an illumination mode;

FIG. 10 is a partial, cross-sectional view of the covering and the window of FIG. 1, with the covering arranged in a deflection mode;

FIG. 11 is a partial, cross-sectional view of another embodiment of a covering as installed on a window, with the covering arranged in an absorption mode;

FIG. 12 is a cross-sectional, schematic illustration of a slat of the covering of FIG. 11;

FIG. 13 is a cross-sectional view of an embodiment of the slat of FIG. 12, arranged at an angle for absorption;

FIG. 14 is a cross-sectional view the slat of FIG. 13, arranged at an angle for illuminating; and

FIG. 15 illustrates another embodiment of a slat for the covering of FIG. 11, shown in different angles for rejecting and absorbing light.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

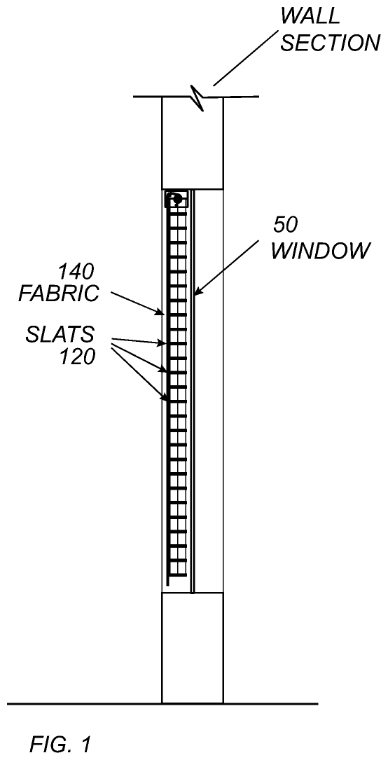

With reference to FIGS. 1 to 4, a motorized covering 100 according to at least some non-limiting embodiments of the present technology is illustrated. Embodiments of the covering 100 are illustrated and described herein as being installed on an interior of a building and generally covering an interior side of a window 50, although it should not be so limited. In different embodiments, or different applications of a same embodiment, coverings according to the present technology could be installed over a plurality of windows, on an exterior of a window or building, in front of skylights and/or selected portions of exterior building walls lacking windows but having thermal loss. In some cases, embodiments of a covering could be installed over different types of architectural openings.

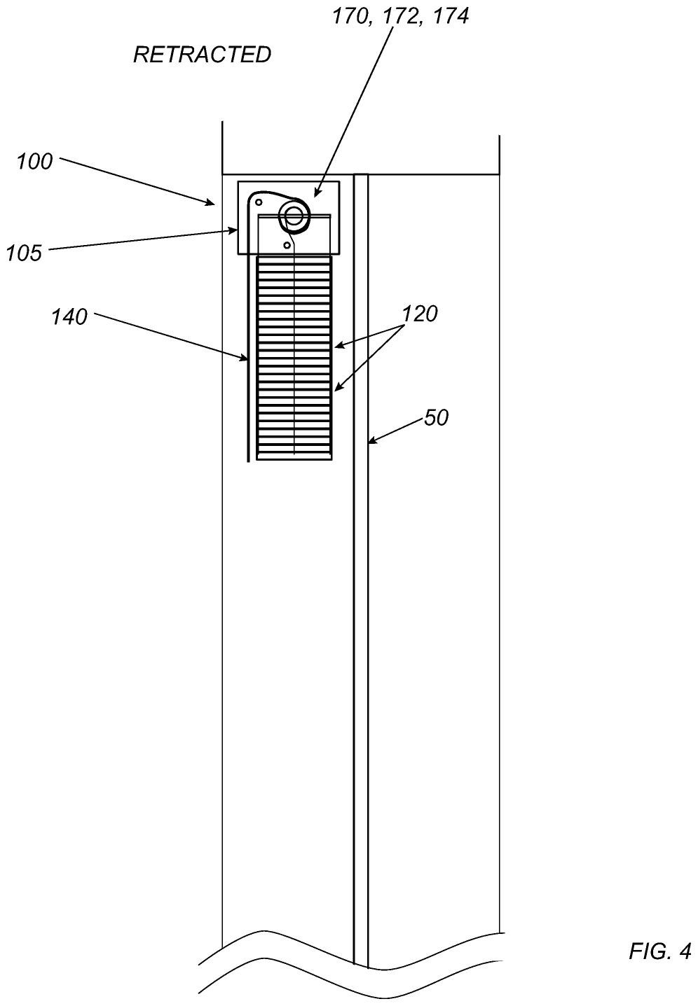

The covering 100 includes a plurality of slats 120 for selectively blocking light passing through the window 50. The slats 120 are selectively positionable, along a generally vertical axis, in an extended position (FIGS. 1 to 3), a retracted position (FIG. 4), as well as a variety of intermediate positions (not shown). In some embodiments, the slats 120 (and thus the covering 100) could have certain pre-determined vertical positions. In other embodiments, the covering 100 could be configured to selectively move to any position from the fully extended position to the fully retracted position. As is described in greater detail below, selectively extending and retracting the slats 120 allows for changing an effective insulation factor for the window 50.

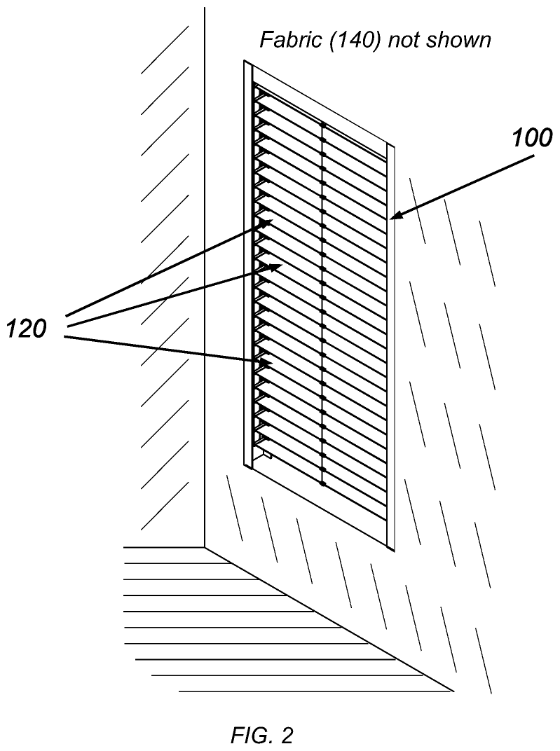

The covering 100 also includes a flexible material layer 140 (removed in FIG. 2). The layer 140 is disposed on a side of the slats 120 opposite the window 50, the slats 120 being disposed between the window 50 and the layer 140 when installed on the window 50. The layer 140 is a generally transparent or translucent material which permits transmission of sunlight, but generally impedes or prevents air flow from between the slats 120 and an exterior of the covering 100. The layer 140, in the present embodiment, is formed from vinyl coated fiberglass fabric with transparencies of 1%, 3%, or 10%. Depending on the particular embodiment, different materials could be used to form the layer 140, including but not limited to: at least partially translucent standard blind/window treatment fabrics, flexible glass laminate (e.g. using EVA, POE, PVA), plastic laminates (e.g. PTE, PTFE, ETFE), and optical films. In at least some embodiments, it is contemplated that the layer 140 could be configured to sealably connect to wall portions surrounding the window 50 to aid in insulating (described further below). Some embodiments of the covering 100 could also include sealing members to further aid in creating the insulating layer over the window 50. One or more sealing members could be arranged to impede air circulation from the plurality of temporary air cells 160 past the flexible material layer 140 when the covering 100 is installed over the window 50.

The layer 140 is connected to the plurality of slats 120 via a header portion 105 of the covering 100, specifically via a motor system 170 (described further below). The flexible material layer 140 extends generally parallel to the window 50 when the slats 120 are in the extended position (as installed over the window 50). It is contemplated that the layer 140 could be connected directly to one or more of the slats 120, for instance a bottom edge of the flexible material layer 140 could be fastened or attached to a bottom most slat 120 in some embodiments.

Although it is contemplated that a second material layer could be included on an interior side of the slats 120, the present embodiment aids in minimizing material and fabrication complexity by utilizing the window 50 itself to aid in enclosing air in between the slats 120 to form the insulating air pockets.

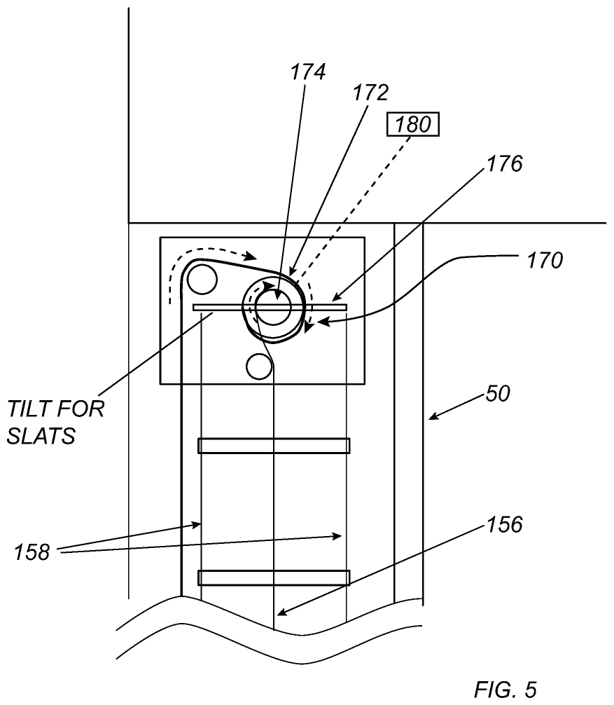

With reference to FIG. 5, the covering 100 also includes a motor system 170 operatively connected to the slats 120 and the flexible material layer 140. The motor system 170 includes two coaxial motors: an exterior rotating motor 172 and a center pivoting motor 174. In different embodiments, the motor system 170 could be formed by one motor having a drivetrain configured to switch between raising/lowering the layer 140/the slats 120 and tilting the slats 120.

The exterior motor 172 rotates to raise and lower the layer 140 and the slats 120 along a general vertical axis. A top edge of the layer 140 is connected to an exterior of the motor 172. When the motor 172 rotates, the layer 140 wraps around the exterior of the motor 172.

In the illustrated embodiment, the covering 100 also includes cords, or strings, for supporting and controlling movement of the slats 120. A plurality of center cords 156 support the slats 120 and are connected to the exterior motor 172. As the motor 172 rotates to lift the layer 140, the cords 156 are also pulled vertically upward to narrow the space between each slat 120 and moving the group of slats 120 generally vertically upward toward the retracted position. When the motor 172 rotates in an opposite direction, the cords 156 and the layer 140 are lowered toward the extended position. It is contemplated that in some embodiments, the layer 140 could be formed with pleats and connected to the motor 172 by one or more cords such that the layer 140 collapses into an accordion-like fold when the covering 100 is moved from the extended position to the retracted position. In at least some embodiments, it is contemplated that the layer 140 and the slats 120 could be connected to an embodiment of the motor system 170 separately such that the layer 140 could be lowered or raised independently from the slats 120.

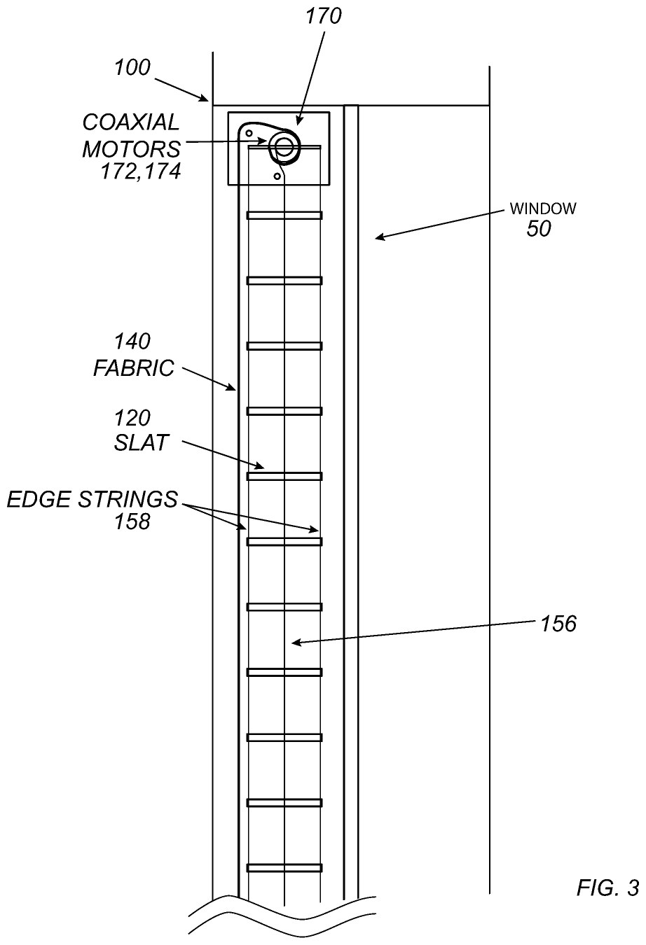

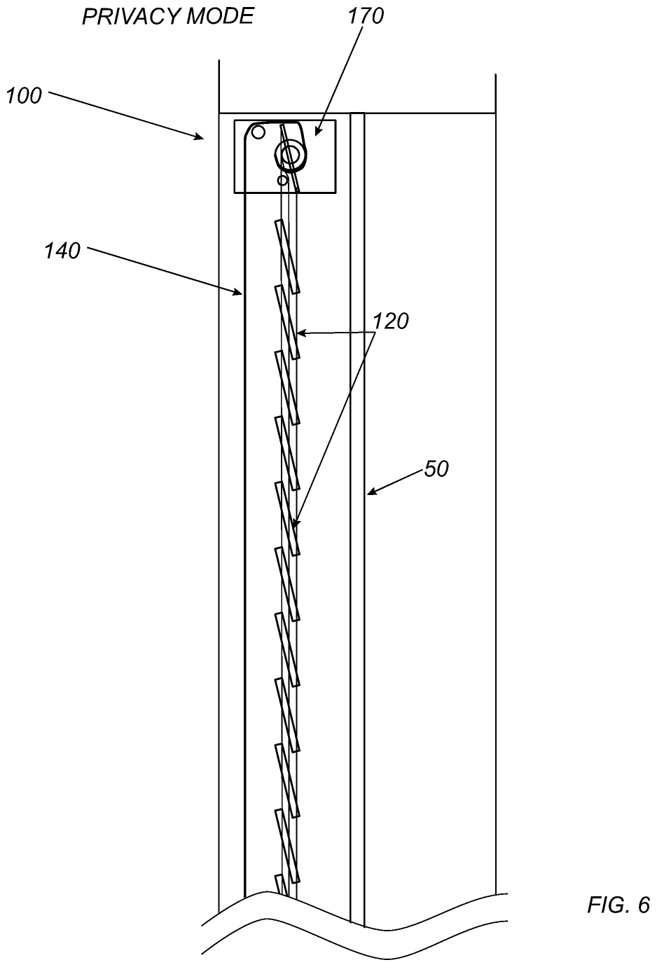

The covering 100 further includes a plurality of edge cords 158 arranged along window-side and layer-side edges of the slats 140 and connected to the center motor 174. In the illustrated embodiment, the motor 174 is connected to a tip-tilt bar 176, the cords 158 being attached to through the bar 176. Upon rotation of the motor 174, cords 158 on opposite ends of the bar 176 are moved vertically in opposite directions by tilting of the bar 176, in turn causing the slats 120 to tilt (i.e. rotate about their centers). The slats 120 are thus further configured to be selectively arrangeable in a plurality of angular positions. The motor system 170 and the plurality of slats 120 are thus configured selectively move the covering 100 between a plurality of mode positions when the covering 100 is in use and installed on the window 50. Depending on the embodiment, the mode positions could include one or more of: a privacy mode with the slats 120 arranged to block light passage through the covering 100 (see FIG. 6), a viewing mode with the slats 120 arranged generally horizontally (see FIG. 3), and a retracted mode with the slats 120 gathered at a top portion of the covering 100 (see FIG. 4).

The covering 100 further includes a controller 180 (shown schematically in FIG. 5), communicatively connected to the motor system 170. In the present embodiment, the controller 180 is programmed to control the motor system 170 according to a control program electronically stored thereto. As will be described further below, the controller 180 communicates control signals to the motor system 170 to selectively move the slats 120 and the layer 140 for purposes of changing an insulation factor for the window 50. In at least some embodiments, it is contemplated that the controller 180 could be communicatively connected to an external computer-implemented device in order to provide the control signals and/or the control program. It is also contemplated that the controller 180 could be omitted in some embodiments, and the motor system 170 could be communicatively connected to an external control device. Depending on the embodiment, the external control device could be a computer external to the covering 100. In at least some embodiments, the controller 180, or the external control device when applicable, could be communicatively connected to sensors. It is further contemplated that some embodiments of the covering 100 could be connected to or include one or more integrated sensors and/or logic controllers.

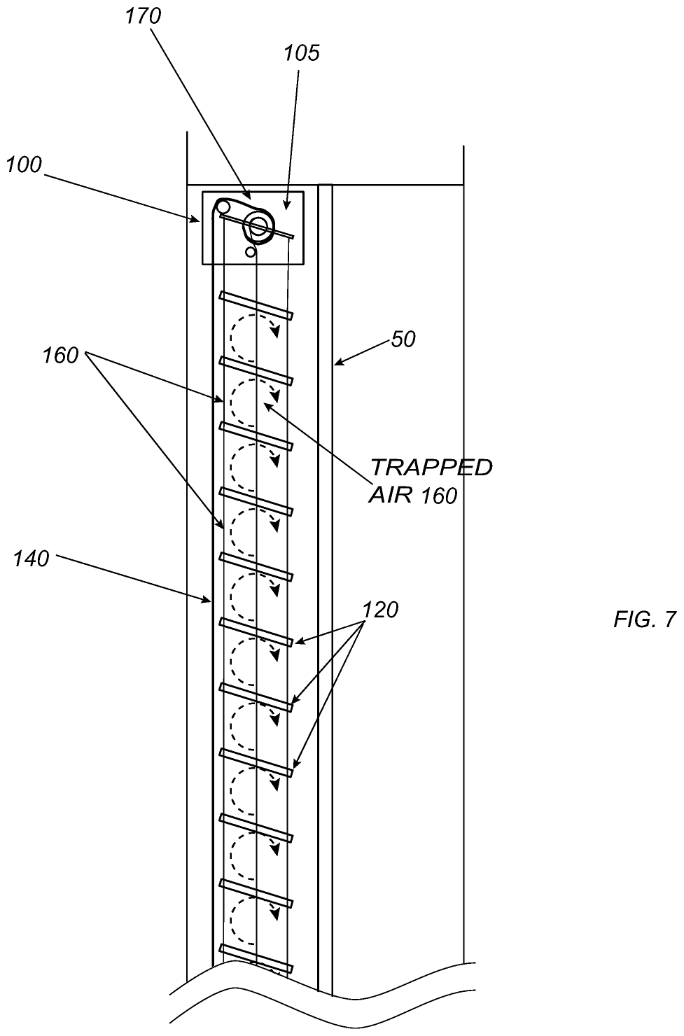

The motor system 170 is configured to lower and raise the slats 120 and the flexible material layer 140 in response to one or more control signals based at least in part on a determination to change an insulation factor for the window 50. As is illustrated schematically in FIG. 7, when the covering 100 is in use, a plurality of temporary air cells 160 are formed between the slats 120, the layer 140, and the window 50 when the slats 120 are in the extended position, or in intermediate positions where space is created between the slats 120. By trapping air between the slats 120, the layer 140, and the window 50, an insulating layer over the window 50 is created, increasing an effective insulation factor for the window 50. It is further noted that the thermal properties of the components of the covering 100 (for instance the layer 140) also contribute to the effective insulation factor for the window 50 covered with the covering 100.

In at least some embodiments, the motor system 170 is further configured to move the slats 120, by raising, lowering, or rotating, in response to the one or more control signals. For example, in some embodiments, the motor system 170 could be configured to selectively tilt or rotate the slats 120 in order to maximize daylight passing through the covering 100 at a particular time of day. Similarly, the control signals could direct the motor system 170 to arrange the covering in the privacy mode at a different time of day. In at least some embodiments, one or more control signals could be produced at least in part by an energy management system. For example, decisions on raising or lowering the covering 100 could be based on the determined heat transmission needs in order to best minimize energy required to heat or cool the building.

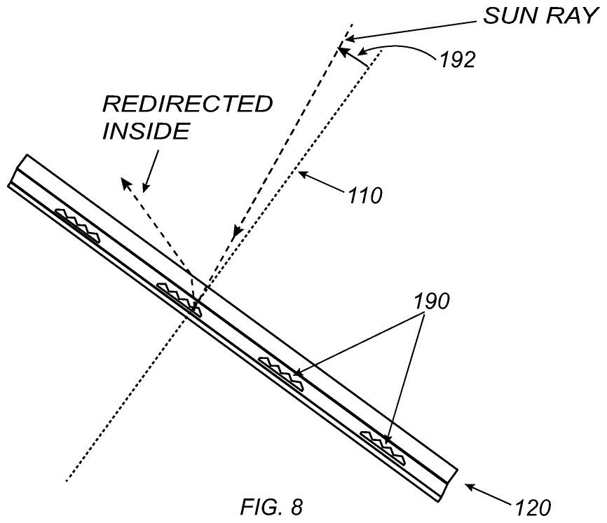

With reference to FIGS. 8 to 10, some embodiments of the covering 100 could include one or more slats 120 which include a scattering surface for scattering or reflecting incident sunlight in a predetermined direction. In the illustrated embodiment, the slats 120 include a plurality of optical facets 190. In some embodiments, it is contemplated that the scattering surface could be implemented in a variety of ways, including but not limited to: gratings, diffuse or Lambertian scattering materials, and fritted glass. It should be noted that the term scattering “surface” is not intended to limit the scattering region to a topmost surface of the slat 120. Scattering or reflecting surfaces could be disposed in an interior of the slat 120, for example, below a lamination surface. It is further contemplated that the scattering surface may cover only some lateral regions of the slats 120.

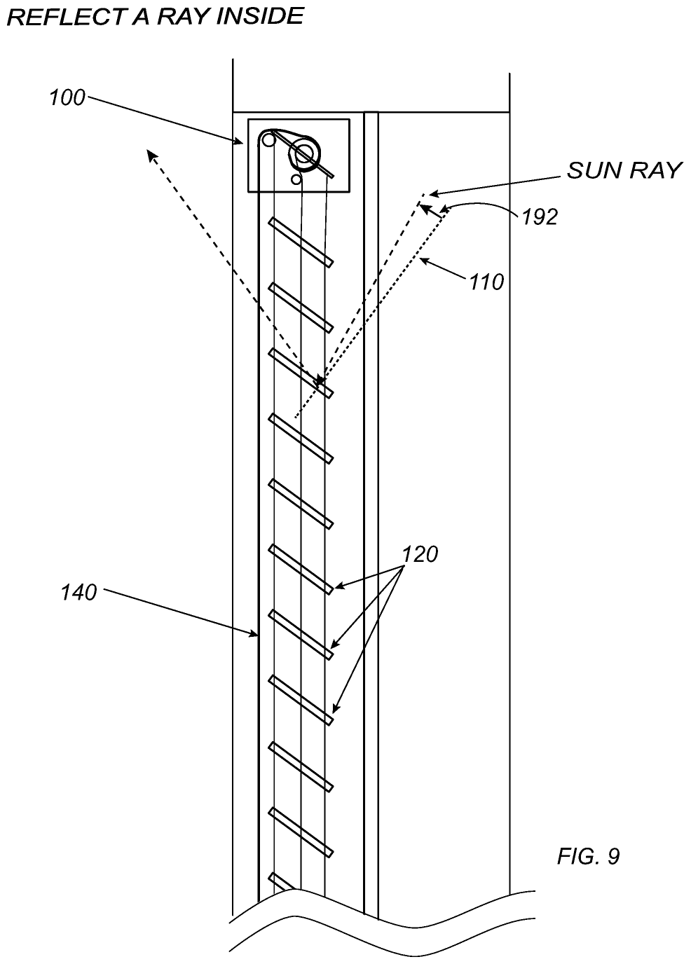

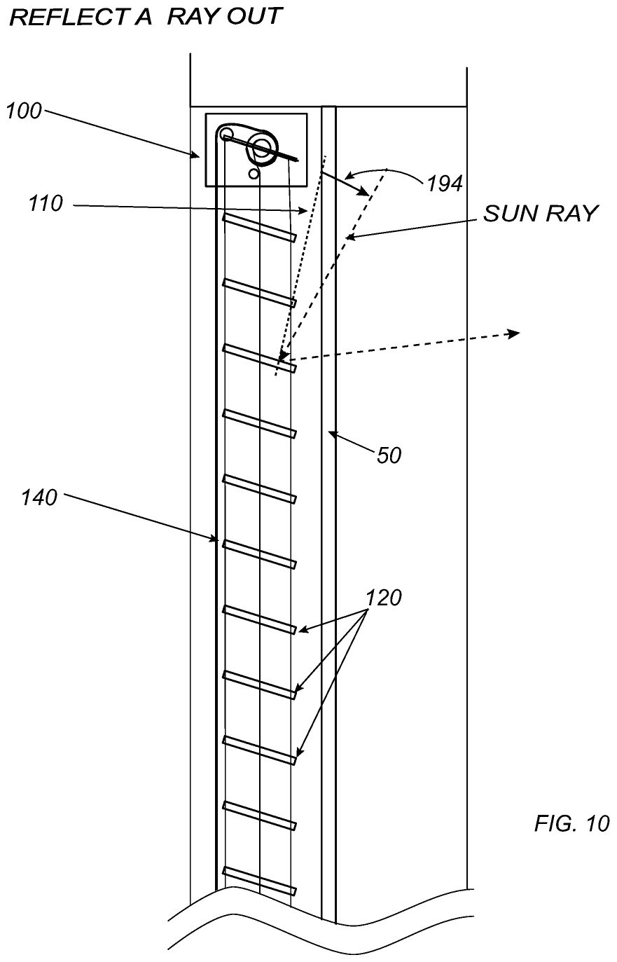

In such embodiments, the motor system 170 is further configured to selectively tilt the slats 120 to scatter incident sunlight thereon in a predetermined direction. As is illustrated in FIGS. 8 and 9, at an incident angle 192 (relative to a normal angle 110 of the given slat 120), incident light is directed inward from the slat 120 and toward the layer 140. At such an angle of the slats 120, natural light is directed into the interior of the building or room, while blocking direct rays from transmitting through the covering 100. As is illustrated in FIG. 10, at an incident angle 194 (relative to the normal 110), incident light is reflected away from the slat 120 and toward the window 50. At such an angle of the slats 120, direct rays from the sun (including the heat associated therewith) are rejected by the covering 100. It should be noted that the particular angles 192, 194 as illustrated are simply non-limiting, illustrative examples, and the particular angles could vary for different embodiments. It is also noted that form of the facets 190 could vary in different embodiments, including by varying form, surface qualities, material properties, or material treatments (such as metallization by depositing metal for partial transparency).

The surfaces described herein having scattering properties, as well as energy absorbing properties described below, are the top sides of the slats 120 (when the slats 120 are arranged generally horizontally). On the bottom side (facing away from the window 50 when in the privacy mode for example), the slats 120 are covered with fabric or material generally chosen for its desired aesthetic properties. In some embodiments, different sides of the slats 120 could be treated to create different aesthetic effects, for instance by applying colors or patterns. The slats 120 could be made with a variety of materials including but not limited to metal, plastic, and paper. It is also contemplated that the bottom sides of the slats 120 could be also be made to reflect or scatter light in a predetermined manner.

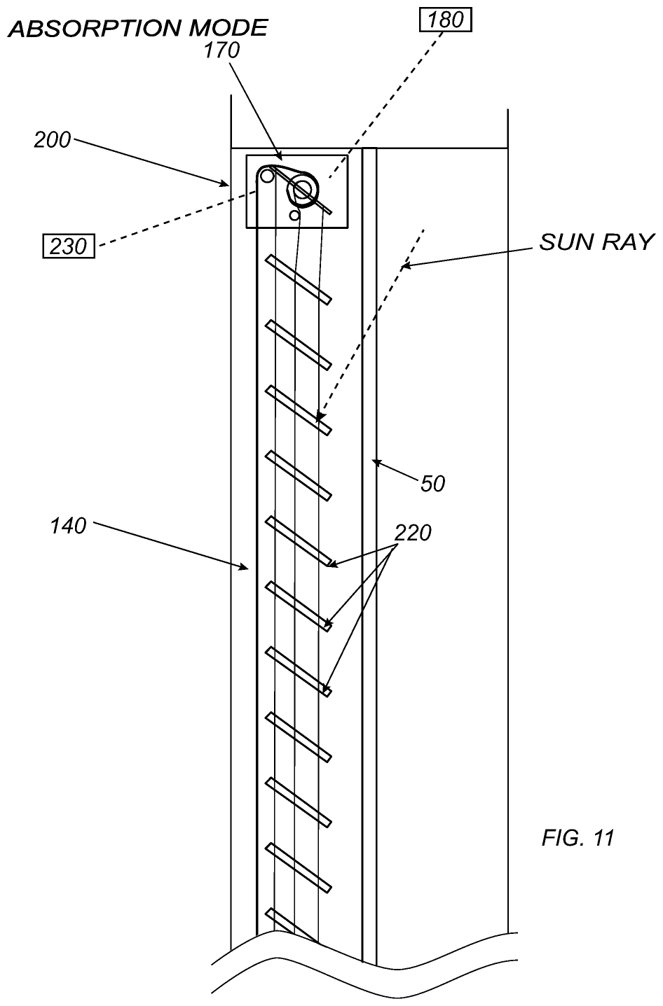

With reference to FIGS. 11 to 14, another embodiment of a motorized covering 200 according to at least some non-limiting embodiments of the present technology is illustrated. Elements of the covering 200 that are similar to those of the covering 100 retain the same reference numeral and will generally not be described again.

Embodiments of the covering 200 are illustrated and described herein as being installed on an interior of a building and generally covering an interior side of the window 50, although it should not be so limited. Similarly to the covering 100, different embodiments of coverings according to the present technology could be installed over a plurality of windows, on an exterior of a window or building, etc.

In addition to managing insulation of and heat transfer through the window 50, described above, the covering 200 is further adapted to generate electricity using sunlight incident on portions of the covering 200. Specifically, the covering 200 includes a plurality of slats 220 for selectively blocking light passing through the window 50 and selectively absorbing solar energy for conversion thereof into electricity.

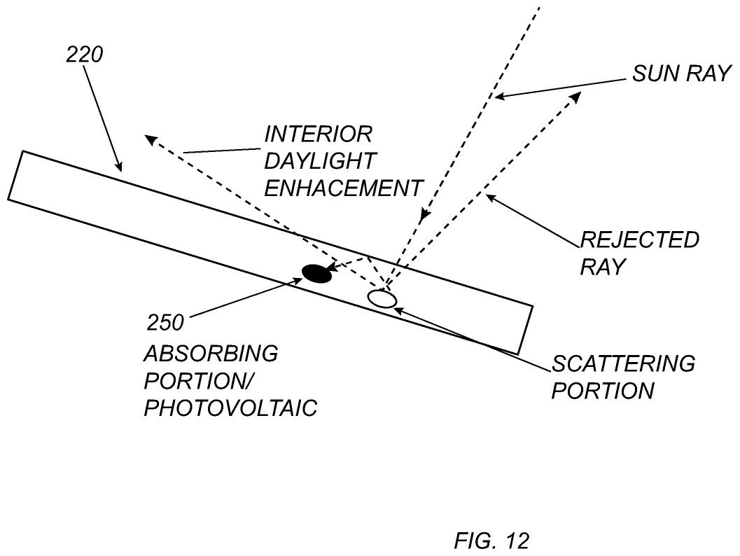

Illustrated for one of the slats 220 in FIGS. 12 to 14, each of the slats 220 includes one or more photovoltaic elements 250. The particular type and arrangement of the photovoltaic elements 250 could vary according to the embodiment. The photovoltaic elements 250 could include but are not limited to: passivated emitter and rear contact (PERC) cells, monocrystalline cells, heterojunction cells, bifacial photovoltaic cell, organic solar cells (OSC), and semi-transparent photovoltaic cells.

As is illustrated schematically in FIG. 11, the covering 200 also includes an electrical collection assembly 230 for collecting electrical energy produced by the photovoltaic elements 250. The assembly 230 is electrically connected to each of the slats 220, and the photovoltaic elements 250 disposed therein. In at least some embodiments, the assembly 230 could be connected to the controller 180 and/or the motor system 170 for providing power thereto. In some such embodiments, energy storage devices could be included, such as capacitors or batteries. The assembly 230 is further configured to electrically connect to external electric systems in order to provide power thereto. For example, the assembly 230 could include, but is not limited to: rechargeable batteries, power over ethernet (POE) devices, and microgrids.

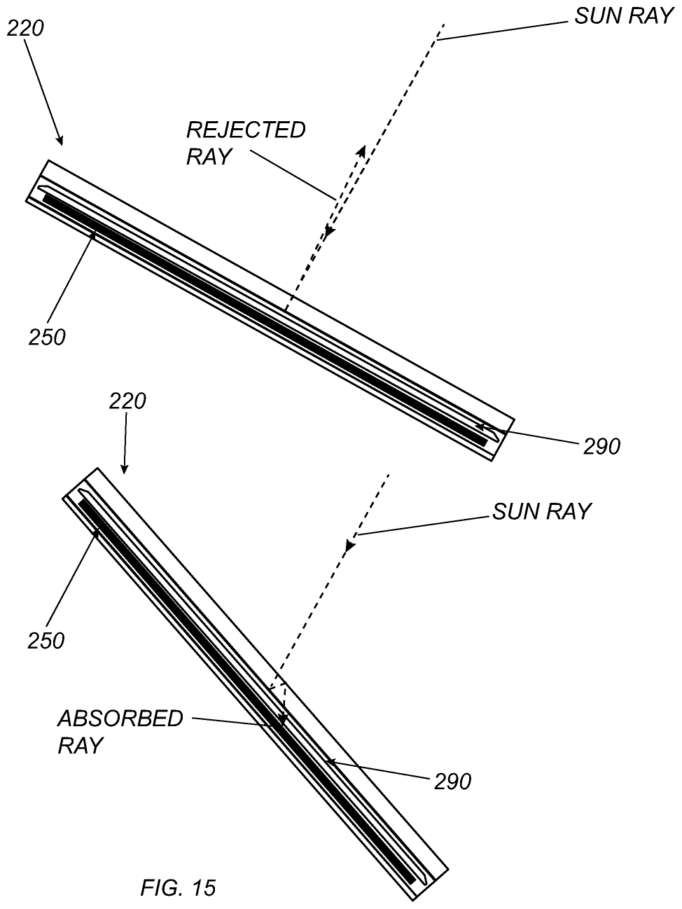

In the illustrated embodiments, each slat 120 further includes light scattering optical facets 190, although it is contemplated that the facets 190 could be omitted in some cases. At some angles of incidence, the facets 190 are be configured to direct light toward the photovoltaic elements 250 by total internal reflection (TIR). At other angles, the facets 190 could be configured to partially toward the elements 250 and partially reflect the light (either into the building for lighting or away for reducing heat, etc.). FIG. 15 illustrates an additional non-limiting embodiment of optical facets 290 for reflecting and scattering incident sunlight, the facets 290 having a uniform form along a short axis of the slats 220 and variations along a long axis of the slats 220 (not shown).

For the covering 200, the motor system 170 is thus further configured to selectively arrange the slats 220 to adjust electricity generation by the photovoltaic elements 250. The adjustment could be made in response to an energy harvesting control signal from the controller 180 for example. In some situations, it could be advantageous, for example, to split incident light between the photovoltaic elements 250 and reflecting light into the building through the covering 100. In such a case, the covering 200 could provide both electricity production and natural lighting. In some cases, the slats 220 could be angled to reduce light incident on the photovoltaic elements 250 due limits on electricity production on the elements 250, in order to avoid overheating thereof.

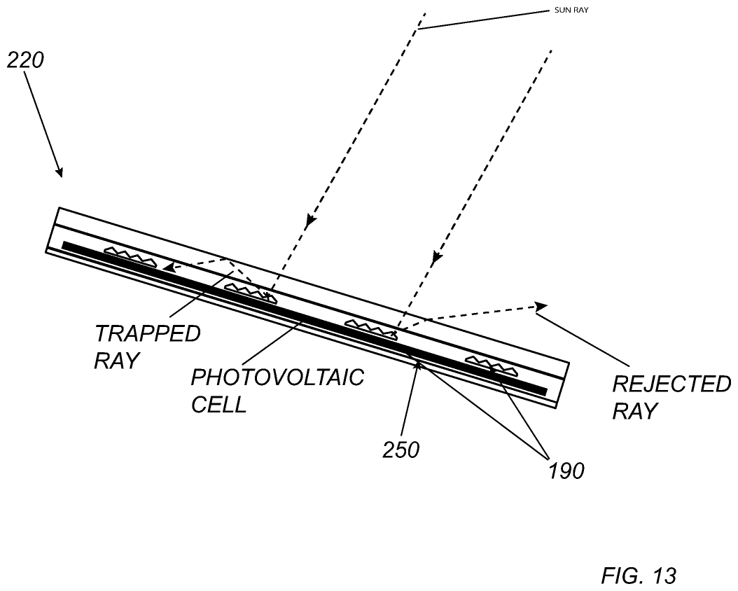

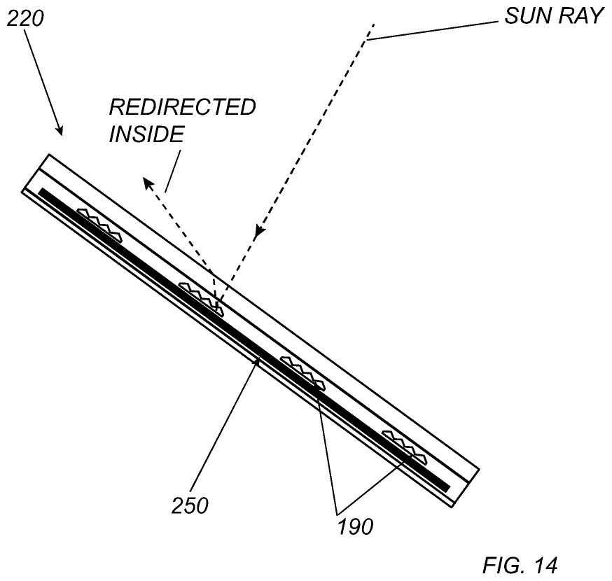

The motor system 170 and the plurality of slats 220 are thus further configured selectively move the covering 200 between additional mode positions when the covering 200 is in use and installed on the window 50. Depending on the embodiment, the mode positions could include one or more of: an energy harvesting mode with the slats 220 arranged to direct at least some incident light toward the photovoltaic elements 250 (see FIGS. 12 to 14), a deflection mode with the slats 220 arranged to reflect at least some incident light back toward the window 50 (see FIG. 13), and an illumination mode with the slats 220 arranged to reflect at least some incident light between the slats 220 and through the flexible material layer 140 (see FIG. 14). As can be seen from the Figures, certain implementations of the deflection mode and the illumination mode overlap with energy harvesting modes.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A motorized covering for a window, the covering comprising:
a plurality of slats selectively positionable in at least an extended position and a retracted position;
a flexible material layer connected to the plurality of slats, the flexible material layer extending generally parallel to the window when the plurality of slats is in the extended position,
a plurality of temporary air cells being formed between the plurality of slats, the flexible material layer, and the window when the plurality of slats is in the extended position; and
a motor system operatively connected to the plurality of slats and the flexible material layer to selectively lower and raise the plurality of slats and the flexible material layer into the extended position and the retracted position,
the motor system being configured to lower and raise the plurality of slats and the flexible material layer in response to at least one control signal, the at least one control signal being based on a determination to change an insulation factor for the window.

2. The covering of claim 1, wherein the motor system is further configured to rotate the plurality of slats in response to the at least one control signal.

3. The covering of claim 1, wherein:
at least one of the plurality of slats includes a light scattering surface; and
the motor system is further configured to selectively tilt the plurality of slats to scatter incident sunlight thereon in a predetermined direction.

4. The covering of claim 3, wherein the motor system is configured to selectively tilt the plurality of slats in order to maximize daylight passing through the covering.

5. The covering of claim 1, wherein:
at least one of the plurality of slats includes at least one photovoltaic element; and
the motor system is configured to arrange the plurality of slats to maximize the electricity generation by the at least one photovoltaic element in response to an energy harvesting control signal.

6. The covering of claim 5, further comprising:
a plurality of optical facets disposed over the at least one photovoltaic element; and
wherein scattering of light incident thereon varies by angle of incidence.

7. The covering of claim 6, wherein:
the plurality of optical facets are configured to direct at least a portion of light incident thereon at a first angle of incidence toward the at least one photovoltaic element when the covering is in use;
the plurality of optical facets are configured to direct at least a portion of light incident thereon at a second angle of incidence reflect light incident thereon toward the flexible material layer when the covering is in use; and
the plurality of optical facets are configured to direct at least a portion of light incident thereon at a third angle of incidence reflect light incident thereon away from the flexible material layer and the at least one photovoltaic element when the covering is in use.

8. The covering of claim 1, wherein the at least one control signal is produced at least in part by an energy management system.

9. A motorized covering for a window, the covering comprising:
a plurality of slats selectively positionable in at least an extended position and a retracted position, each of the plurality of slats including:
at least one photovoltaic element;
at least one flexible material layer connected to the plurality of slats, the at least one flexible material layer extending generally parallel to the window when the plurality of slats is in the extended position;
an electrical collection assembly for collecting electrical energy produced by the at least one photovoltaic element of each of the plurality of slats; and
a motor system operatively connected to the plurality of slats and the flexible material layer to selectively move the plurality of slats and the flexible material layer,
the motor system being configured to move the plurality of slats and the flexible material layer in response to at least one control signal.

10. The covering of claim 9, wherein the motor system is configured to selectively lower, raise, and rotate the plurality of slats.

11. The covering of claim 9, further comprising:
a plurality of optical facets disposed over the at least one photovoltaic element; and
wherein scattering of light incident thereon varies by angle of incidence.

12. The covering of claim 11, wherein:
the plurality of optical facets are configured to direct at least a portion of light incident thereon at a first angle of incidence toward the at least one photovoltaic element when the covering is in use;
the plurality of optical facets are configured to direct at least a portion of light incident thereon at a second angle of incidence reflect light incident thereon toward the flexible material layer when the covering is in use; and
the plurality of optical facets are configured to direct at least a portion of light incident thereon at a third angle of incidence reflect light incident thereon away from the flexible material layer and the at least one photovoltaic element when the covering is in use.

13. The covering of claim 9, wherein the motor system is configured to selectively tilt the plurality of slats in order to maximize daylight passing through the covering.

14. The covering of claim 9, wherein the motor system is configured to arrange the plurality of slats to maximize the electricity generation by the at least one photovoltaic element of each slat in response to an energy harvesting control signal.

15. The covering of claim 9, wherein the at least one control signal is produced at least in part by an energy management system.

16. The covering of claim 9, wherein the motor system and the plurality of slats are configured to be selectively moveable between a plurality of mode positions when the covering is in use and installed on the window, the plurality of mode positions comprising:
a privacy mode with the plurality of slats arranged to block light passage through the covering;
an energy harvesting mode with the plurality of slats arranged to direct at least some incident light toward the at least one photovoltaic cell of each of the plurality of slats;
a deflection mode with the plurality of slats arranged to reflect at least some incident light back toward the window;
an illumination mode with the plurality of slats arranged to reflect at least some incident light between the plurality of slats and through the flexible material layer;
a viewing mode with the plurality of slats arranged generally horizontally; and
a retracted mode with the plurality of slats gathered at a top portion of the covering.
